(19) United States
(12) Patent Application Publication
(10) Pub. No.: US 2008/0042848 A1
(43) Pub. Date: Feb. 21, 2008

(54) Licence plate

(76) Inventors: Arthur Roberts, Wellington (NZ); Mathias Martin Ernerst Ehlen, Upper Hutt (NZ)

Correspondence Address: DANN, DORFMAN, HERRELL & SKILLMAN, 1601 MARKET STREET, SUITE 2400, PHILADELPHIA, PA, 19103-2307, US

(21) Appl. No.: 11/598,908

(22) Filed: Nov. 14, 2006

(30) Foreign Application Priority Data
Aug. 15, 2006 (NZ) 549173

(51) Int. Cl. G08B 13/14

(52) U.S. Cl. 340/572.7; 340/572.8

(57) ABSTRACT

The present invention relates to vehicle license plates and a method of making vehicle license plates having an integrated antenna for use with radio frequency identification (RFID) devices. In a preferred form, the license plate 10 of the present invention comprises a conductive sheet 12 forming at least part of the license plate 10, a slot 14 or notch provided on the conductive sheet 12, and a radio frequency transponder operatively coupled to the conductive sheet 12 to use the slot 14 or notch as an antenna.

### FIELD OF THE INVENTION

The present invention relates to license plates. In particular, but not exclusively, the present invention relates to vehicle license plates and a method of making license plates having an integrated antenna for use with radio frequency identification (RFID) devices.

### BACKGROUND TO THE INVENTION

The identity of a vehicle is typically determined by manually reading or recording the registration of the vehicle noted on its license plate. To automate this manual process in the past, various forms of technology relating to license plate recognition have been proposed.

More recently, there have been proposals to employ radio frequency identification (RFID) tags on license plates. Such proposals typically involve an external placement of an RFID tag on the license plate of a vehicle, or manufacturing the license plate such that the RFID tag is incorporated between two surfaces of the license plate. An example proposal is described in US Patent Application No. 2004/0263357.

The reference to the above patent application has been made for the purpose of providing a context for discussing the features of the present invention. Reference to the patent application should not be construed as an admission that the application is prior art or forms part of the common general knowledge in the art in any jurisdiction.

It is an object of the present invention to either provide a license plate and a method of making a license plate for improved RFID applications, or at least provide the public with a useful choice.

### SUMMARY OF THE INVENTION

In a first aspect, the present invention broadly consists in a license plate comprising:
a conductive sheet forming at least part of the license plate;
a slot or notch provided on the conductive sheet; and
a radio frequency transponder operatively coupled to the conductive sheet to use the slot or notch as an antenna.

In a second aspect, the present invention broadly consists in a method of making a license plate, the method comprising the steps of:
making a slot or notch on a conductive sheet that forms at least part of the license plate; and
placing a radio frequency transponder on the conductive sheet to allow the transponder to use the slot or notch as an antenna.

In a third aspect, the present invention broadly consists in a license plate comprising:
a conductive sheet forming at least part of the license plate; and
a slot or notch provided on the conductive sheet, wherein the slot or notch is adapted to receive a radio frequency transponder operable at a wavelength λ and to allow the transponder to use the slot or notch as an antenna, wherein if a slot is provided, the length of the slot is about λ/2, and if a notch is provided, the length of the notch is about λ/4.

In a fourth aspect, the present invention broadly consists in a license plate comprising:
a conductive sheet forming at least part of the license plate; and
a slot or notch provided on the conductive sheet, wherein the slot or notch is adapted to receive at least part of a dielectric insert containing a radio frequency transponder to allow the transponder to use the slot or notch as an antenna.

In a fifth aspect, the present invention broadly consists in a license plate comprising a slot or notch antenna formed on the license plate.

Preferably, the slot or notch is tuned to the UHF frequency band of 860 MHz to 960 MHz.

Preferably, the notch is a straight notch or folded notch. Preferably, the slot is a straight slot or a folded slot.

Preferably, the conductive sheet is an aluminium sheet forming the license plate.

Preferably, the conductive sheet forms a layer on the license plate. In one form, the conductive sheet is a metal cladding, such as copper cladding, on the license plate. In this form, the transponder is preferably affixed to the conductive sheet using adhesive.

Preferably, the transponder is provided on a dielectric insert that is attached to the conductive sheet. Preferably, the insert includes an extension that is received in the slot or notch. Preferably, the insert is attached to the conductive sheet such that the insert cannot be removed without damaging the plate. In one form, the insert is secured to the plate using a plurality of rivets. In another form, the insert is secured to the plate using strong adhesive. In yet another form, the insert is welded onto the plate.

Preferably, the license plate has a solid metal backing.

Preferably, the step of placing a radio frequency transponder on the conductive sheet comprises attaching a dielectric insert containing the transponder to the conductive sheet.

Preferably, the insert includes an extension that is received in the slot or notch.

Preferably, the method of the present invention further comprises the step of securing the dielectric insert to the license plate such that the insert cannot be removed without damaging the plate. In one form, the insert is secured to the plate using a plurality of rivets.

The term ‘slot’ as used in this specification means an elongate opening provided on a conductive sheet, with the opening being bounded by the conductive sheet. The opening may be linear or curvilinear, and uniform or non-uniform.

The term ‘notch’ as used in this specification means an elongate opening provided on a conductive sheet, with one end of the opening not being bounded by the conductive sheet. The opening may be linear or curvilinear, and uniform or non-uniform.

The term ‘transponder’ as used in this specification means an electronic device that is able to receive radio signals from a transmitter and that is able to transmit signals back to the transmitter using radio frequency. The transponder may be a ‘passive’ RFID transponder that has no built-in power source, but is powered by the magnetic field of the transmitter (inductive coupling) or by the electric field of the transmitter (capacitive coupling) when it is in close proximity to a transmitter or reader. The transponder may also be an ‘active’ RFID transponder that has a built-in power source.

The term ‘comprising’ as used in this specification means ‘consisting at least in part of’, that is to say when interpreting statements in this specification which include that term, the features, prefaced by that term in each statement, all need to be present but other features can also be present.

This invention may also be said broadly to consist in the parts, elements and features referred to or indicated in the specification of the application, individually or collectively, and any or all combinations of any two or more said parts, elements or features. Where specific integers are mentioned herein which have known equivalents in the art to which this invention relates, such known equivalents are deemed to be incorporated herein as if individually set forth.

### BRIEF DESCRIPTION OF THE FIGURES

Preferred forms of the present invention will now be described with reference to the accompanying figures in which:

FIGS. 1A and 1B show schematic forms of the license plate of the present invention;

FIGS. 2A-2C show example slots and notches provided on schematic forms of the license plate of the present invention;

FIG. 3 shows another schematic form of the license plate of the present invention; and

FIGS. 4A to 4D show an example form of the license plate of the present invention.

### DETAILED DESCRIPTION OF THE PREFERRED FORMS

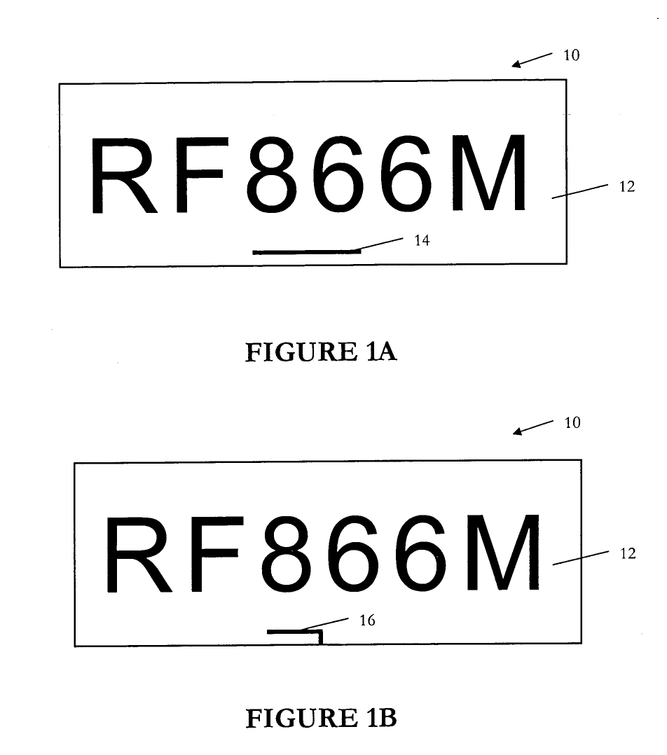

Referring to FIGS. 1A and 1B, preferred forms of the license plate of the present invention are shown generally as 10. The license plate 10 includes a conductive sheet 12, which may be, for example, an aluminium sheet. As in conventional license plates, the sheet 12 of the license plate 10 includes a registration number. The license plate 10 may be manufactured either: (i) with the registration number, such as by embossing the sheet 12 with the required registration number, or (ii) without the registration number, which would be later applied by way of printing, for example. It is therefore not essential for the license plate of the present invention to include a registration number.

In one form, the license plate of the present invention is shaped so as to form an antenna for a radio frequency transponder on the license plate. In FIG. 1A, the license plate 10 has been shaped so as to have a slot 14 under the registration number. In FIG. 1B, the license plate has been shaped so as to have a folded notch 16 under the registration number. The placements of the slot and notch in the figures are only example placements. Skilled persons will appreciate that the slot and notch can be placed in another location or orientation on the sheet 12.

Although not shown in FIGS. 1A and 1B, a radio frequency transponder is operatively coupled to the sheet 12 so as to use the slot 14 or notch 16 as an antenna. This will be described in further detail below.

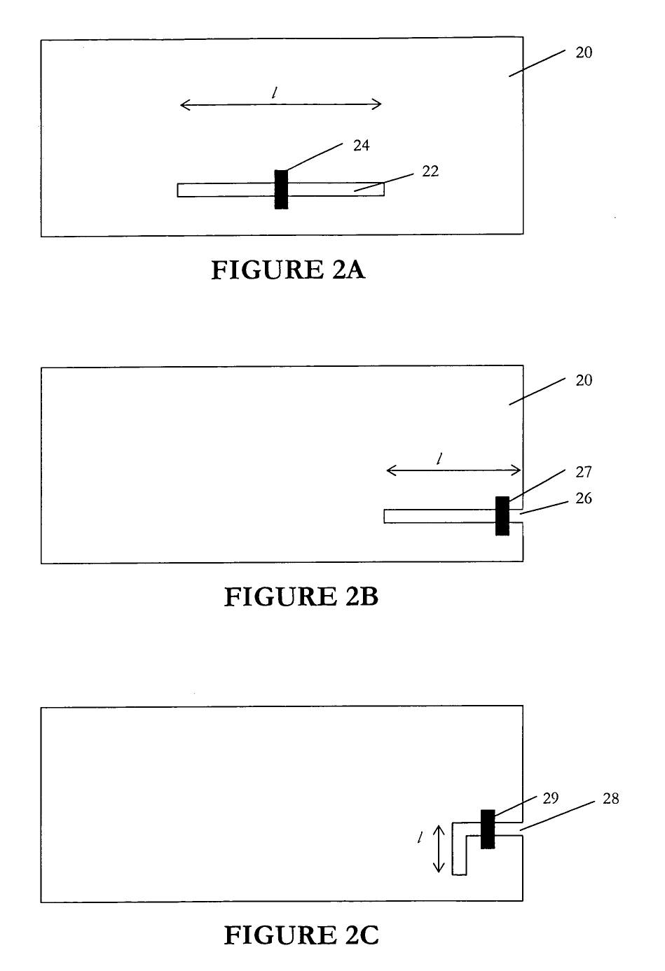

Referring to FIG. 2A, a close-up view of the license plate of FIG. 1A is shown. The conductive sheet of the plate is shown as 20 and the slot is shown as 22. Operatively attached to the slot 22 is a radio frequency transponder 24.

The transponder 24 may be chosen from the range of transponders offered by iPico, or from any other manufacturer that produces transponders operable under the EPC UHF Generation 2 standard. These are of course preferred examples of transponders. Where desired or necessary, other forms of transponders or standards may be used instead.

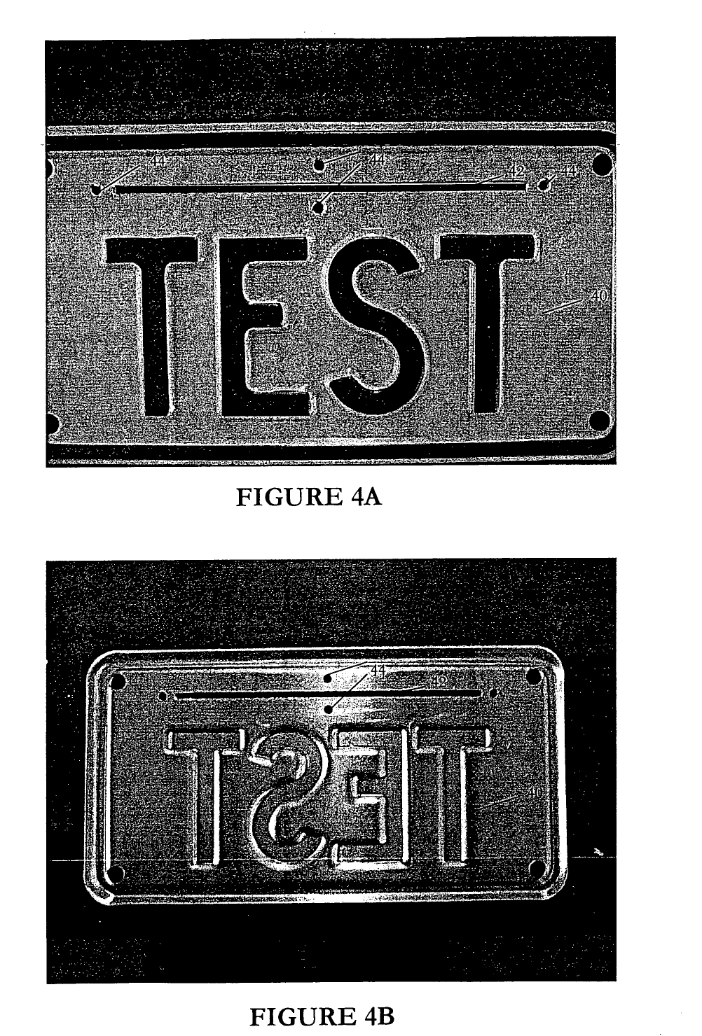

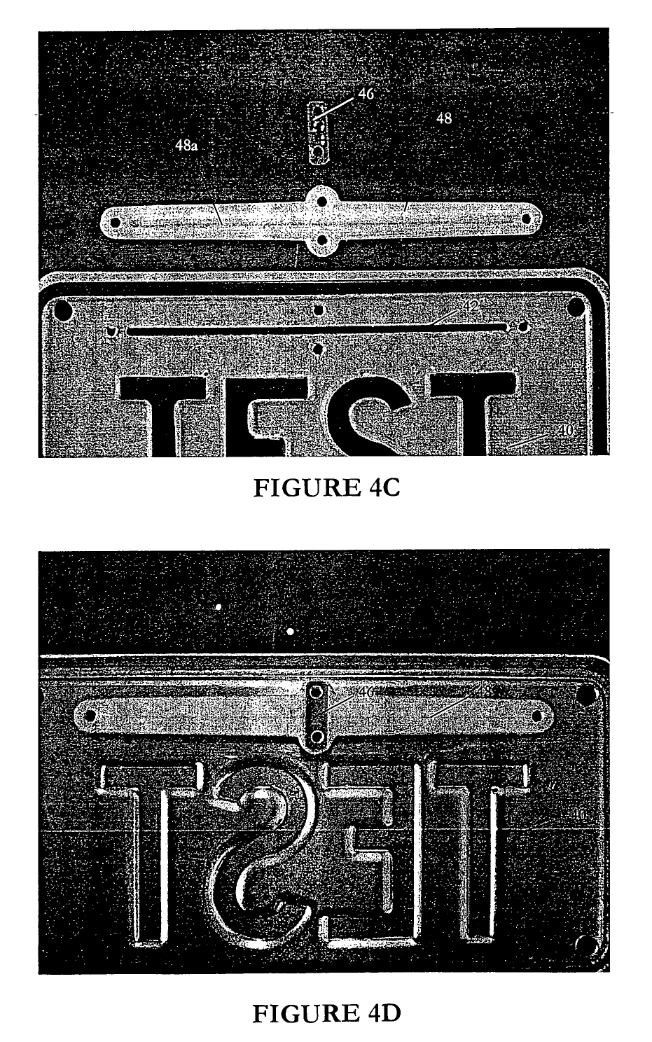

In the preferred form, the transponder 24 is capacitive-coupled to the sheet 20. This could be done by attaching the transponder 24 to a dielectric insert, such as a plastic insert preferably having a dielectric constant of 2, that covers and fills the slot 22, for example. This insert attachment is preferred and will be described in further detail with reference to FIGS. 4C and 4D. It is, however, not essential. Skilled persons will appreciate that the transponder 24 can be attached to the sheet 20 in other ways, including directly attaching a suitably shaped transponder to the sheet. It is also not essential for the transponder 24 to be attached to the middle of the slot 22. Depending on the impedance of the transducer, it may be placed away from the middle of the slot 22.

The slot has a length, l, which, in one form, is substantially equal to half of the operating wavelength of the transponder 24. In mathematical terms, l≈λ/2, where λ is the operating wavelength of the transponder. Because of the wideband nature of the transponder, the length of the slot is not crucial. Skilled persons will appreciate that the length may be altered or designed with a specific purpose or transponder in mind. For instance, where an insert with dielectric properties is used to attach the transponder to the sheet 20, the length of the slot will be reduced. For the preferred form plastic insert having a dielectric constant of 2, the slot length is preferably reduced by about 40%. The slot length can also be altered to take into account the properties of the material making up the license plate. As will be described, the plate may include a fibreglass sheet, for instance FR4, which has a dielectric constant of 4. In this form, the slot length is preferably reduced further.

Although only a linear slot is shown in the figure, it is possible for the present invention to have a more complex slot formed on the conductive sheet. For instance, a folded slot might be formed. The folding point of the folded slot may also be varied. It should be noted that a folded slot will result in different horizontal and vertical components of signals being transmitted from and received by the folded slot. This affects the gain of the folded slot. For instance, if the slot was folded halfway along its length, the gain would be halved for each of the horizontal and vertical components.

Referring to FIG. 2B, a close-up view of a license plate having a notch is shown. The conductive sheet of the plate is shown as 20 and the notch is shown as 26. Operatively attached to the notch 26 is a radio frequency transponder 27. The notch preferably has a length, l, substantially equal to a quarter of the operating wavelength of the transponder 27. In mathematical terms, l≈λ/4, where λ is the operating wavelength of the transponder.

Referring to FIG. 2C, a close-up view of a license plate having a folded notch is shown. The conductive sheet of the plate is shown as 20 and the folded notch is shown as 28. Operatively attached to the folded notch 28 is a radio frequency transponder 29. As with the notch 26 of FIG. 2B, the folded notch 28 also preferably has a length, l, substantially equal to a quarter of the operating wavelength of the transponder 29.

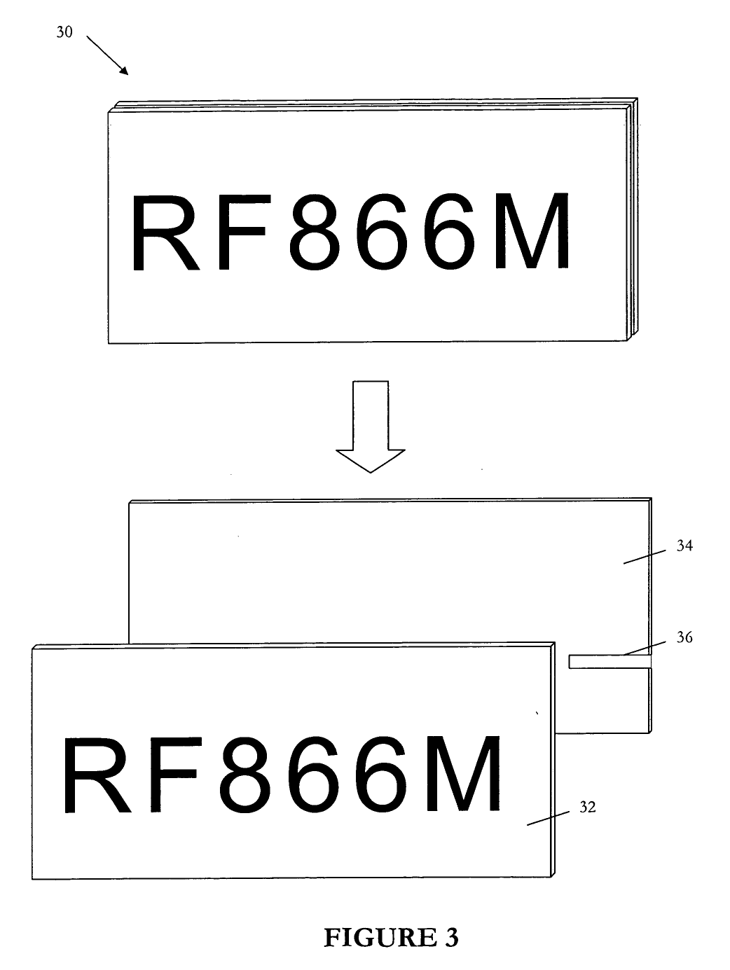

Another form of the license plate of the present invention in shown in FIG. 3. The license plate is shown generally as 30 and comprises a front sheet 32 and a back sheet 34. The front sheet 32 is preferably made from FR4 fibreglass, with the registration number on the sheet 32 being applied using an automated paint jet machine such as that manufactured by Numtec Interstahl. Alternatively, the front sheet 32 may be a standard plate and the back sheet 34 may be made from FR4 fibreglass. The back sheet 34 is the conductive sheet on which a slot or notch 36 is formed. Alternatively, the slot or notch may be placed in the front sheet, similar to the slot and notch illustrated in FIGS. 1A and 1B. In one form, the back sheet 34 is a copper cladding applied to the back of the front sheet 32. While the back sheet 34 is shown substantially the same size as the front sheet 32, this is not essential. The back sheet 34 or the conductive sheet of the license plate can form only part of the license plate, such as where the back sheet 34 forms a smaller area on the back of the front sheet 32.

In the form shown in FIG. 3, the license plate can be made more rigid than typical aluminium license plates. Also, because the slot or notch can be made to the cladding of the license plate, there is no need to provide a through-and-through slot or notch on the license plate. It should be noted that more than two surfaces or layers may be used to make the license plate. In this form, one or more of the surfaces may be provided with the slot or notch antenna.

In use, the above described forms of the license plate of the present invention allows radiation to be transmitted both forwardly and backwardly of the slot or notch. This brings about a reduction in gain as the transmission backwardly of the slot or notch is not able to be received by readers, which in turn results in a waste of transmission power. This also makes the license plate sensitive to the presence of metal behind the license plate. This sensitivity may not be substantial as there is usually no large metal surfaces located close to the back of the license plate (unless the vehicle is a large truck, in which case there may be such a metal surface). However, if the backwardly radiation should be suppressed, the license plate of the present invention may be provided with a solid metal backing. Preferably, the backing is a metal plate located about 6 mm behind the layer containing the slot/notch.

By using the license plate itself as the antenna, the present invention allows the use of transponders that do not require an in-built antenna. Such transponders are not only cost effective, but are also robust. Also, because the transponder requires operative coupling with the license plate to have RFID function, the present invention makes it difficult for users to remove the transponder from the plate without destroying the plate's RFID function. Furthermore, it has been found that the gain of the license plate improves the reading distance of the transponder compared to conventional transponders having built-in antennas.

To manufacture the license plate of the present invention, the method of the present invention provides the steps of making a slot or notch on a conductive sheet of the license plate, and placing a radio frequency transponder on the conductive sheet to allow the transponder to use the slot or notch as an antenna. The step of placing a radio frequency transponder preferably comprises attaching a dielectric insert containing the radio frequency transponder to the conducting sheet. In one form, the insert is a plastic insert that is at least partly received in the slot or notch. In the preferred form, the insert includes an extension that substantially fills the slot or notch. The step of placing a radio frequency transponder is preferably done using an automated placement machine. The step of placing a radio frequency transponder preferably also comprises sealing the transponder in the license plate. In one form, the sealing is done using an adhesive, such as an Araldite® adhesive.

### EXAMPLE

One example license plate of the present invention is shown generally as 40 in FIGS. 4A and 4B. The license plate 40 includes a slot 42 that is tuned to the UHF frequency band of 860 MHz to 960 MHz, most preferably to 866 MHz or 915 MHz. For instance, the slot 42 may be tuned to 866 MHz in New Zealand, 869 MHz in Europe, 915 MHz in the US and Australia, and 950 MHz in Japan. The specific frequencies used for other countries will depend on the local radio regulations of those countries. In the form shown, the slot 42 has a length of 130 mm. Four holes 44 are provided for attaching the transponder to the license plate.

Referring to FIG. 4C, the license plate 40 is shown together with a transponder 46 and a plastic insert 48. The transponder in this example has an operational frequency of 896 MHz at 500 mW. The plastic insert 48 is provided with an extension 48a that is adapted to be received in the slot 42 of the license plate 40. The plastic insert 48 or at least the extension 48a is preferably of the same colour as the background of the front of the license plate so that the slot 42 is concealed after installation of the transponder.

The license plate 40, transponder 46 and plastic insert 48 are shown assembled in FIG. 4D. Although not visible in the figure, the extension of the plastic insert is received in the slot of the license plate so as to substantially fill the slot. The plastic insert 48 is provided with holes that correspond to the holes provided on the license plate and is preferably attached to the license plate using aluminium rivets (not shown). As shown in the figure, the transponder 46 is attached to the plastic insert 48. In an alternative embodiment, the transponder 46 may be contained in the plastic insert 48.

It should be noted that the specifications above are only examples. The operational frequency and power of the transponder will vary depending on the legal requirements of countries and specific applications of the present invention. Also, the requirement for a plastic insert can be dispensed with, depending on the application. The specific attachment using four holes and rivets may be altered or replaced with any suitable alternative, and preferably permanent, fasteners, such as pin fasteners or special purpose fasteners. Alternatively, the plastic insert and transponder may be fully integrated into the plate.

### APPLICATIONS OF THE INVENTION

Applications of the license plate of the present invention will now be described by way of example only. The applications should not be read as limiting the present invention in any way.

The license plate of the present invention may be provided with an RFID transponder having memory to store information about a vehicle, such as the validity of the registration and the Vehicle Identification Number (VIN), for example. Associated systems may use information obtained from the license plate of the present invention to provide access control, automated tolling, asset tracking, traffic flow monitoring, and vehicle crime and non-compliance.

The license plate of the present invention may also be interfaced with one or more computers in the vehicle to provide further functionality. For instance, the vehicle computer may be programmed to only function if the information obtained from the license plate is verifiable. This prevents fake or incorrect license plates from being fitted to a vehicle. The license plate may also interface with a vehicle's security system to prevent tampering or theft of the license plate.

The foregoing describes the invention including preferred forms thereof. Alterations and modifications as will be obvious to those skilled in the art are intended to be incorporated within the scope hereof, as defined by the accompanying claims.

1. A license plate comprising:
a conductive sheet forming at least part of the license plate;
a slot or notch provided on the conductive sheet; and
a radio frequency transponder operatively coupled to the conductive sheet to use the slot or notch as an antenna.

2. The license plate as claimed in claim 1, wherein the slot or notch is tuned to the UHF frequency band of 860 MHz to 960 MHz.

3. The license plate as claimed in claim 1, wherein the notch is a straight notch or a folded notch, and the slot is a straight slot or a folded slot.

4. The license plate as claimed in claim 1, wherein the conductive sheet forms the front of the license plate.

5. The license plate as claimed in claim 1, wherein the conductive sheet forms a layer on the license plate.

6. The license plate as claimed in claim 5, wherein the conductive sheet is a metal cladding.

7. The license plate as claimed in claim 1, wherein the transponder is provided on a dielectric insert that is attached to the conductive sheet.

8. The license plate as claimed in claim 7, wherein the insert includes an extension that is received in the slot or notch.

9. The license plate as claimed in claim 7, wherein the insert is attached to the conductive sheet using one or more of: a plurality of rivets, adhesive and welding.

10. The license plate as claimed in claim 1, wherein the license plate has a solid metal backing.

11. A license plate comprising:
a conductive sheet forming at least part of the license plate; and
a slot or notch provided on the conductive sheet, wherein the slot or notch is adapted to receive a radio frequency transponder operable at a wavelength λ and to allow the transponder to use the slot or notch as an antenna, wherein if a slot is provided the length of the slot is about λ/2, and if a notch is provided, the length of the notch is about λ/4.

12. A license plate comprising:
a conductive sheet forming at least part of the license plate; and
a slot or notch provided on the conductive sheet, wherein the slot or notch is adapted to receive at least part of a dielectric insert containing a radio frequency transponder to allow the transponder to use the slot or notch as an antenna.

13. A method of making a license plate, the method comprising the steps of:
making a slot or notch on a conductive sheet that forms at least part of the license plate; and
placing a radio frequency transponder on the conductive sheet to allow the transponder to use the slot or notch as an antenna.

14. The method as claimed in claim 13, wherein the step of placing a radio frequency transponder on the conductive sheet comprises attaching a dielectric insert containing the transponder to the conductive sheet.

15. The method as claimed in claim 14, wherein the insert includes an extension that is received in the slot or notch.

16. The method as claimed in claim 14 further comprising the step of securing the dielectric insert to the license plate using one or more of: a plurality of rivets, adhesive and welding.

17. The method as claimed in claim 13, wherein the slot or notch is tuned to the UHF frequency band of 860 MHz to 960 MHz.

18. The method as claimed in claim 13, wherein the notch is a straight notch or a folded notch, and the slot is a straight slot or a folded slot.

19. The method as claimed in claim 13, wherein the conductive sheet forms the front of the license plate.

20. The method as claimed in claim 13, wherein the conductive sheet forms a layer on the license plate.
